(19) United States
(12) Patent Application Publication
(10) Pub. No.: US 2026/0236058 A1
(43) Pub. Date: Aug. 13, 2026

(54) PEDAL ASSEMBLY

(71) Applicant: KSR IP Holdings, LLC, Wilmington, DE (US)

(72) Inventor: Wjatscheslaw Kauz, Pattensen (DE)

(73) Assignee: KSR IP Holdings, LLC, Wilmington, DE (US)

(21) Appl. No.: 19/539,761

(22) Filed: Feb. 13, 2026

Related U.S. Application Data
(60) Provisional application No. 63/757,941, filed on Feb. 13, 2025.

(51) Int. Cl. G05G 1/46

(52) U.S. Cl. CPC G05G 1/46

(57) ABSTRACT

Embodiments herein are directed to a pedal assembly that includes a pedal arm member, a blade member package, and a sensing assembly. A plurality of protrusions extend from an interior surface of the pedal arm member. The blade member package has a plurality of blade members stacked in a vertical arrangement. The blade member package is received by the plurality of protrusions to couple the blade member package to the interior surface of the pedal arm member. The sensing assembly includes at least one force measurement elements configured to sense a change in force. When a load is applied to the pedal arm member, the pedal arm member and the blade member package are driven into the at least one force measurement element configured to measure a force applied by the blade member package indicative of an amount of the load applied to the pedal arm member.

### CROSS-REFERENCE TO RELATED APPLICATIONS

This utility patent application claims priority benefit from U.S. Provisional Patent Application Serial No. 63/757,941, filed February 13, 2025, and entitled “Force Transducer Pressure Pedal Assembly with Wake-Up Switch”, the entire contents of which is incorporated by reference herein in its entirety.

### TECHNICAL FIELD

The present specification generally relates to pedal assemblies for vehicles and, more specifically, to pedal assemblies utilizing force transducer assemblies.

### BACKGROUND

Conventional pedal assemblies include a pedal arm that is pivotally coupled to a housing at one end and a pedal pad positioned on an opposite end. In these pedal assemblies, various inductive or Hall Effect type sensors are positioned within the housing to measure the amount of pivot of the pedal arm with respect to the a target. When a force is applied to the pedal pad, the pedal arm pivots and, based on the amount of pivot, generally electric motors control the vehicle accordingly. However, in floor mounted pedal pads, a user may not apply the same pressure or load over the entire pedal pad. As such, load balancing and measuring small amount of travel of the pedal arm are issues. Accordingly, there is a need for pedal assemblies that have load balancing and measure minimal force and/or travel of the pedal pad.

### SUMMARY

In one embodiment, a pedal assembly is provided. The pedal assembly includes a housing, a pedal arm member, a blade member package, and a sensing assembly. The pedal arm member is movably coupled to the housing. The pedal arm member has an interior surface and an opposite exterior surface. A plurality of protrusions extend from the interior surface of the pedal arm member. The blade member package has a plurality of blade members stacked in a vertical arrangement. The blade member package is received by the plurality of protrusions to couple the blade member package to the interior surface of the pedal arm member. The sensing assembly is positioned within the housing. The sensing assembly includes at least one force measurement element configured to sense a change in force. When a load is applied to the pedal arm member, the pedal arm member and the blade member package are driven into the at least one force measurement element configured to measure a force applied by the blade member package indicative of an amount of the load applied to the pedal arm member based on the amount of change of the force.

In another embodiment, an assembly is provided. The assembly includes a housing, a pedal arm member, a blade member package, and a sensing assembly. The pedal arm member is movably coupled to the housing. The pedal arm member has an interior surface and an opposite exterior surface. The pedal arm member further includes a plurality of protrusions extending from the interior surface of the pedal arm member and a pair of resilient members extending from the interior surface of the pedal arm member. The blade member package has a plurality of blade members stacked in a vertical arrangement. The blade member package is received by the plurality of protrusions to abut an inner surface thereof and by the pair of resilient members to couple the blade member package to the interior surface of the pedal arm member. The sensing assembly is positioned within the housing and includes at least one force measurement element configured to sense a change in force. When a load is applied to the pedal arm member, the pedal arm member and the blade member package are driven into the at least one force measurement element configured to measure a force applied by the blade member package indicative of an amount of the load applied to the pedal arm member based on the amount of change of the force from an idle position.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a perspective side view of an example pedal assembly according to one or more embodiments shown and described herein;

FIG. 2 schematically depicts a partially exploded perspective view of the example pedal assembly of FIG. 1 according to one or more embodiments shown and described herein;

FIG. 3 schematically depicts an isolated perspective bottom view of a pedal arm member of the example pedal assembly of FIG. 2, according to one or more embodiments shown and described herein;

FIG. 4A schematically depicts a partially isolated plan rear view of a sensing assembly, a pedal pad, a pedal carrier, and the pedal arm member in an assembled state of the example pedal assembly of FIG. 2, according to one or more embodiments shown and described herein;

FIG. 4B schematically depicts a partially isolated plan rear view from beneath of the sensing assembly, the pedal pad, the pedal carrier, the pedal arm member, and a blade member package in the assembled state of the example pedal assembly of FIG. 4A, according to one or more embodiments shown and described herein;

FIG. 5 schematically depicts a partially isolated perspective view of the pedal arm member and the blade member package in the assembled state of the example pedal assembly of FIG. 4B, according to one or more embodiments shown and described herein;

FIG. 6A schematically depicts an isolated perspective side and top view of one blade member of the blade member package of the example pedal assembly of FIG. 5, according to one or more embodiments shown and described herein;

FIG. 6B schematically depicts an isolated perspective other side and top view of the one blade member of the blade member package of the example pedal assembly of FIG. 6A, according to one or more embodiments shown and described herein;

FIG. 7 schematically depicts an example graphical representation of a spring and kickdown performance of one blade member of the blade member package and of the blade member package of the example pedal assembly of FIG. 4B, according to one or more embodiments shown and described herein;

FIG. 8A schematically depicts an isolated top and side perspective view of the sensing assembly of FIG. 2, according to one or more embodiments shown and described herein;

FIG. 8B schematically depicts an isolated top and other side perspective view of the sensing assembly of FIG. 8A, according to one or more embodiments shown and described herein;

FIG. 8C schematically depicts an isolated bottom and side perspective view of the sensing assembly of FIG. 8A, according to one or more embodiments shown and described herein;

FIG. 9 schematically depicts an isolated top and side perspective view of one force measurement element of the pair of force measurement elements of the sensing assembly according to one or more embodiments shown and described herein;

FIG. 10A schematically depicts an isolated perspective view of a sensor housing and components of a printed wiring assembly of the sensing assembly of FIG. 2 according to one or more embodiments shown and described herein;

FIG. 10B schematically depicts an isolated perspective view of a circuit board and the sensor housing and components of the printed wiring assembly of the sensing assembly of FIG. 2 according to one or more embodiments shown and described herein;

FIG. 11A schematically depicts an isolated perspective view of a plurality of slats of an upper housing member of the sensing housing coupled to a lower housing member of the sensing housing member of FIG. 10B, according to one or more embodiments shown and described herein;

FIG. 11B schematically depicts an isolated zoomed perspective view of the plurality of slats of the upper housing member of the sensing housing coupled to the lower housing member of the sensing housing member of FIG. 10B in a deformed position to seal the upper housing member and the lower housing member, according to one or more embodiments shown and described herein;

FIG. 12A schematically depicts an isolated perspective top and side view of a sensor housing of the sensing assembly of FIG. 8A, according to one or more embodiments shown and described herein;

FIG. 12B schematically depicts an isolated perspective bottom and other side view of the sensor housing of the sensing assembly of FIG. 12A, according to one or more embodiments shown and described herein;

FIG. 13 schematically depicts an isolated wiring schematic of the sensing assembly of FIG. 8A, according to one or more embodiments shown and described herein;

FIG. 14A schematically depicts a partially isolated perspective side view of a second aspect of an example pedal assembly including a piezoelectric switch and a biasing member assembly according to one or more embodiments shown and described herein;

FIG. 14B schematically depicts a rear plan view of the pedal arm member and the sensing assembly of the example pedal assembly of FIG. 14A, according to one or more embodiments shown and described herein;

FIG. 14C schematically depicts a side and top partially isolated view of the pedal arm and the sensing assembly of the example pedal assembly of FIG. 14A, according to one or more embodiments shown and described herein;

FIG. 14D schematically depicts a side and top partially isolated perspective view of the sensing assembly of the example pedal assembly of FIG. 14A, according to one or more embodiments shown and described herein;

FIG. 15A schematically depicts a partial isolated perspective view of the biasing member assembly and the sensing assembly of FIG. 14A, according to one or more embodiments shown and described herein;

FIG. 15B schematically depicts a partial exploded perspective view of the biasing member assembly of FIG. 15A, according to one or more embodiments shown and described herein;

FIG. 16 schematically depicts a cross sectional view of the example pedal assembly of FIG. 14A taken from line 16-16, according to one or more embodiments shown and described herein;

FIG. 17 schematically depicts an example graphical representation of at least one force measurement element with a spring blade stroke or displacement of the spring blade package of the example pedal assembly of FIG. 1, according to one or more embodiments shown and described herein; and

FIG. 18 schematically depicts an example graphical representation of a force profile between idle pedal position up to fully applied pedal position of the example pedal assembly of FIG. 1, according to one or more embodiments shown and described herein.

### DETAILED DESCRIPTION

Embodiments described herein are directed to pedal assemblies that are configured for minimal travel pedal applications by measuring a change in force using a force measurement elements, such as, without limitation, strain gauges indicative of a force applied to a pedal cover. The pedal assembly is arranged such that the force applied to anywhere on the pedal cover is detected. Further, a wake-up switch is positioned to be activated by slight movements of the pedal pad. The wake-up switch may include circuitry that is configured to send a signal or stop sending a signal to a printed wiring assembly (PWA) and/or an external electronic control unit (ECU), which in turn causes the PWA and/or ECU to wake up from an idle state into an operational state for power consumption savings.

The pedal pad assembly includes a pedal arm, an electronic module, and a plurality of blade members within a blade member package. Each of the plurality of blade members are positioned to be between and engage with the an interior surface of the pedal arm, and may be engaged with a plurality of protrusions and/or tab members extending from the interior surface of the pedal arm that may be resilient members to lock or otherwise couple the each of the plurality of blade members to the interior surface of the pedal arm. As such, the plurality of blade members may be stacked together in a vertical arrangement to achieve a desired force curve. The plurality of protrusions and/or tab members assist in positioning the plurality of blade members and in maintaining a predetermined defined preload which must be overcome by the load to get a brake action (e.g., a start force). As such, the predetermined defined preload may be customized. As a load is applied to the pedal cover, the pedal arm and the plurality of blade members are driven into a portion of the sensing assembly that includes at least one force measurement element configured to measure the force, such as strain, applied by the plurality of blade members. Further, the plurality of blade members are sized and shaped to bend or flex to a predetermined amount of force applied thereon to reduce overloading the force measurement elements.

As used herein, the term “communicatively coupled” means that coupled components are capable of exchanging data signals with one another such as, for example, electrical signals via conductive medium or a non-conductive medium, though networks such as via Wi-Fi, Bluetooth, and the like, electromagnetic signals via air, optical signals via optical waveguides, and the like.

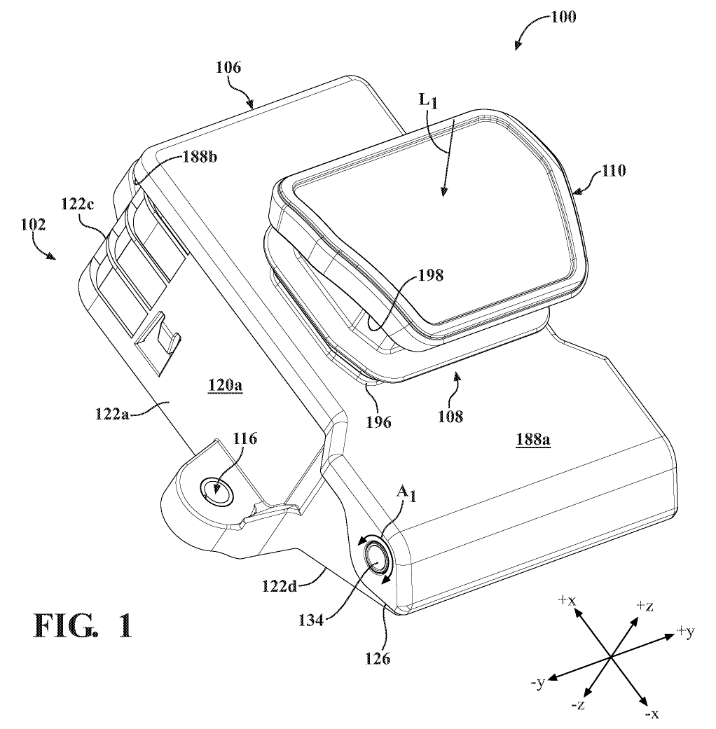

As used herein, the term “assembly lateral direction” refers to the cross-direction of the system (i.e., in a +/- Y direction of the coordinate axes depicted in FIG. 1). The term “assembly longitudinal direction” refers to the forward-rearward direction (i.e., along the +/- X axis of the coordinate axes depicted in FIG. 1), and is transverse to the lateral direction. The term “assembly vertical direction” refers to the upward-downward direction of the system (i.e., in the +/- Z direction of the coordinate axes depicted in FIG. 1).

Now referring to FIGS. 1-5, an example pedal assembly 100 is schematically depicted. The pedal assembly 100 may include a housing 102, a pedal arm member 104, a pedal cover 106, a pedal pad carrier 108, a pedal pad 110, a blade member package 112, and a sensing assembly 114. The housing 102 may be configured to removably mount to an external surface or other vehicle components, such as, but not limited, to a floorboard of a vehicle. The housing 102 may be configured to mount to the external surface through a plurality of mounting apertures 116, each of the plurality of mounting apertures 116 sized to receive at least one fastener and compression limiters 117. For example, and without limitation, each of the plurality of mounting apertures 116 may receive a screw, rivet, bolt, adhesive, weld, hook and loop, and/or the like.

The housing 102 may be include a partially continuous wall 118 that has an outer surface 120a and an opposite inner surface 120b, and a floor surface 120c that defines or forms a pair of sidewalls 122a, 122b, an end wall 122c, and a floor 122d. The housing 102 includes a cavity 124 between the pair of sidewalls 122a, 122b, the end wall 122c, and the floor 122d. Opposite of the end wall 122c is a pivot end 126 of the housing 102. The pivot end 126 may include a flange portion 128 that extends in the assembly vertical direction (i.e., in the +/- Z direction) from the floor surface 120c. The flange portion 128 includes an aperture 130 extending therethrough in the assembly lateral direction (i.e., in the +/- Y direction). Further, each of the pair of sidewalls 122a, 122b at the pivot end 126, include an aperture 132a, 132b extending in the assembly lateral direction (i.e., in the +/- Y direction). The apertures 130, 132a, 132b in the pivot end 126 are configured to receive an elongated member 134 that is configured as a pivot member. That is, as discussed in greater detail herein, the elongated member 134 may also be received by the pedal arm member 104 and the pedal cover 106 to movably couple to the housing 102 and is configured to permit for movement of the pedal arm member 104 about the elongated member 134, as depicted by arrow A1 in FIG. 1.

The pedal arm member 104 includes an interior surface 136a, and an opposite exterior surface 136b to define a thickness of a body 136c. A user interaction portion 138 extends from the exterior surface 136b of the body 136c in the assembly vertical direction (i.e., in the +/- Z direction). The user interaction portion 138 may generally be a continuous wall 140 that has an outer surface 142 and terminates at a top wall 144 with a top wall surface 146. Further, opposite of the user interaction portion 138 in the assembly longitudinal direction (i.e., in the +/- X direction) is a pivot portion 148 of the body 136c. The pivot portion 148 may include a pair of ears 150a, 150b extending from the body 136c. Each of the pair of ears 150a, 150b extend from the body in a generally assembly longitudinal direction (i.e., in the +/- X direction) and maintain the same or similar thickness of the body 136c by the continuation of the interior surface 136a, and the exterior surface 136b to a terminating radius portion 152a, 152b, respectively. Each of the pair of ears 150a, 150b include an aperture 154a, 154b extending therethrough in the assembly lateral direction (i.e., in the +/- Y direction). Each of the apertures 154a, 154b are configured to receive the elongated member 134 to movably couple the pedal arm member 104 to the housing 102, as discussed in greater detail herein.

The interior surface 136a of the pedal arm member 104 may further include plurality of protrusions 156 extending therefrom. Each of the plurality of protrusions 156 may be spaced apart and be semi-circular in shape and have a retaining surface 158a, opposite a wall surface 158b. It should be appreciated that while in the depicted embodiments, the plurality of protrusions 156 are illustrated as semi-circular in shape, this is non-limiting and the each of the plurality of protrusions 156 may be any shape including, without limiting, regular shaped, irregular shaped, triangle, elliptical, octagonal, hexagonal, and/or the like. The retaining surface 158a of each of the plurality of protrusions 156 are configured to receive or abut a portion of the blade member package 112 to assist in the retaining and/or the positioning of the blade member package 112 at a desired position and distance from the interior surface 136a and an amount of force applied the sensing assembly 114 (e.g., a predetermined defined preload) in the assembly vertical direction (i.e., in the +/- Z direction), as discussed in greater detail herein.

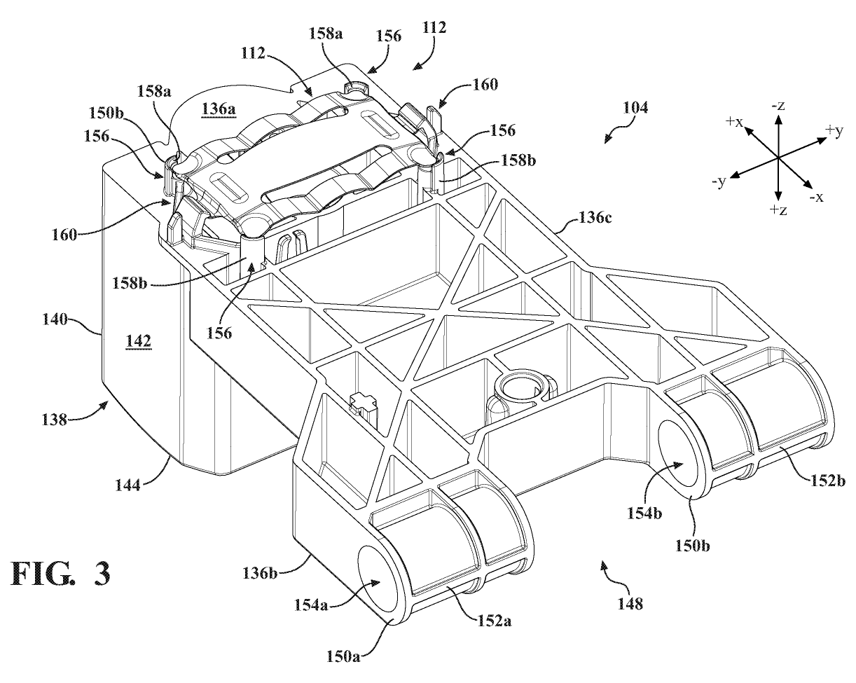

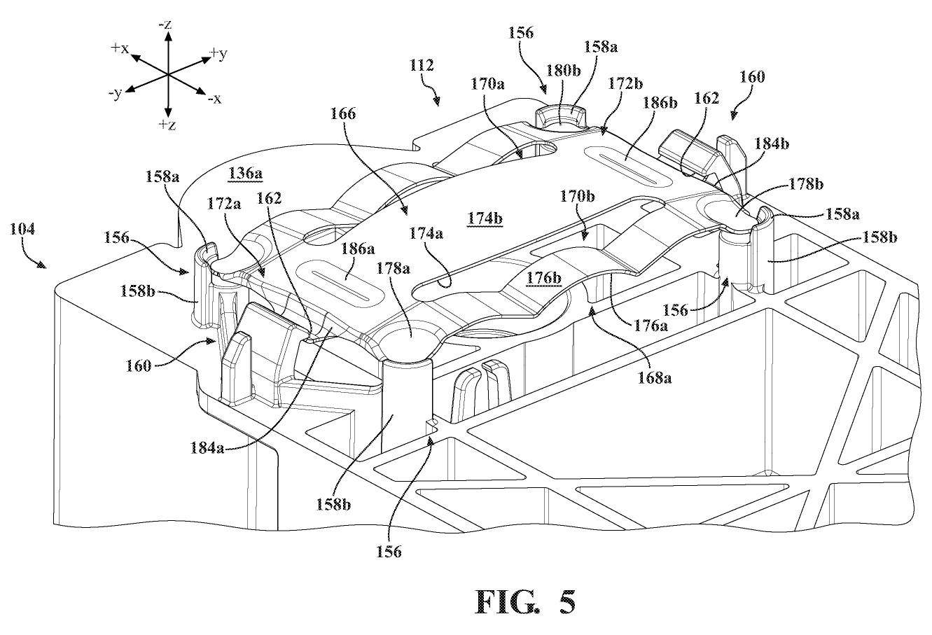

The interior surface 136a of the pedal arm member 104 may further include a pair of resilient members 160 that each include a tab member 162. Each of the tab members 162 are configured to releasably engage with the blade member package 112. That is, each of the tab members 162 are configured to abut or contact portions of the blade member package 112 to assist in the retaining of the blade member package 112 to the interior surface 136a at the desired position and distance from the interior surface 136a and the sensing assembly 114 in the assembly vertical direction (i.e., in the +/- Z direction). Each of the pair of resilient members 160 may be positioned at opposite ends of the interior surface 136a in the assembly lateral direction (i.e., in the +/- Y direction) and positioned between adjacent spaced pairs of the plurality of protrusions 156, as best illustrated in FIGS. 3 and 5.

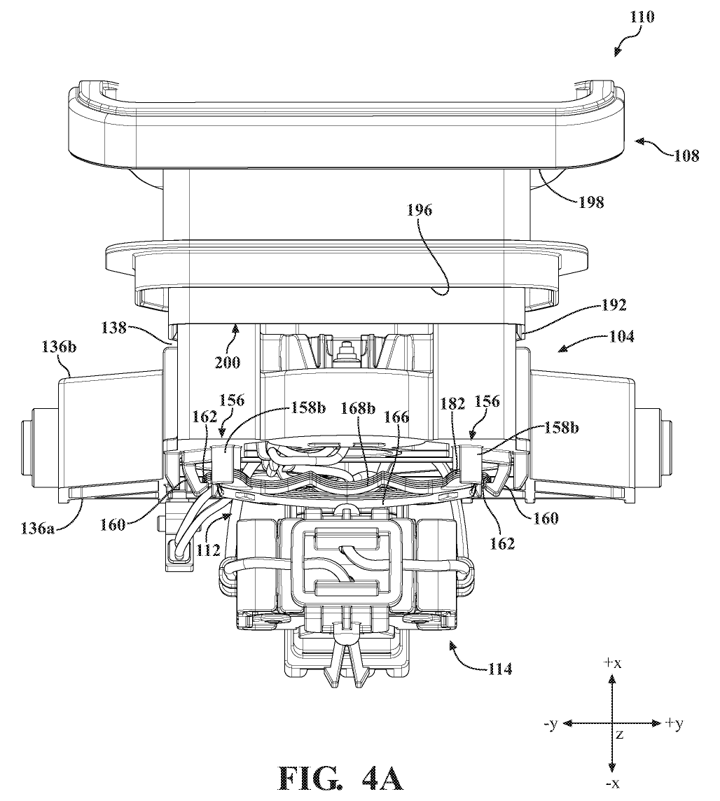

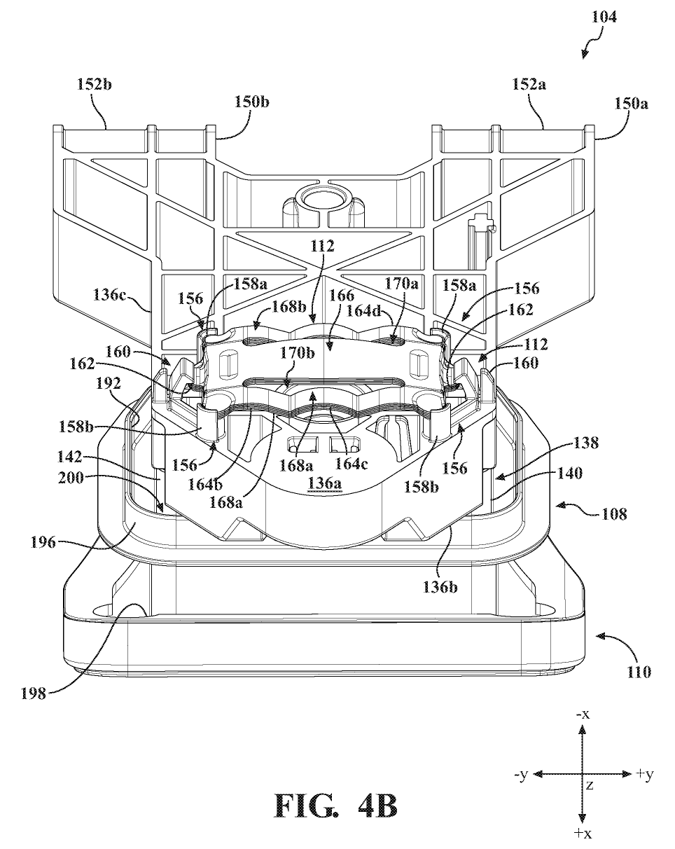

The blade member package 112 may include a plurality of blade members 164, depicted as four blade members 164a, 164b, 164c, 164d in a vertical stacked arrangement in the assembly vertical direction (i.e., in the +/- Z direction) in FIGS. 4A-4B. This is non-limiting and there may be more or less than four blade members. Further, as discussed herein, the blade member package 112 is received by the plurality of protrusions and/or the resilient members 160 and tab members 162 thereof to couple the blade member package 112 to the interior surface 136a at the desired position and distance from the interior surface 136a and the sensing assembly 114 in the assembly vertical direction (i.e., in the +/- Z direction).

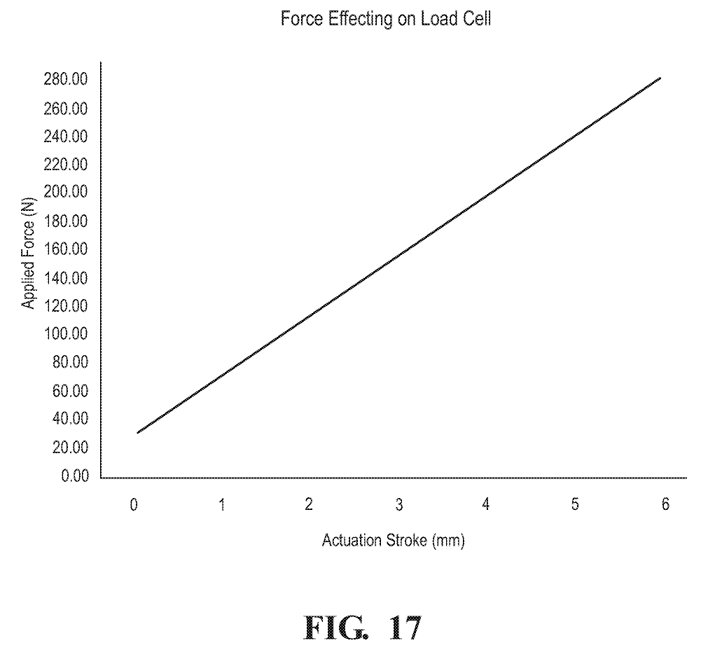

For example, when the pedal arm member 104 is in an idle position (e.g., no load L1 applied to the pedal pad 110), the blade member package 112 may be positioned at a predetermined distance between each of the interior surface 136a and at a predetermined force applied on the sensing assembly 114 in the assembly vertical direction (i.e., in the +/- Z direction), known as the predetermined defined preload. The predetermined defined preload is a starting force that needs to be overcome by the load to get a brake action (e.g., a start force). As such, the predetermined defined preload may be customized by changing the predetermined force applied on the sensing assembly 114 when the pedal arm member 104 is in the idle position. In a non-limiting example, FIG. 17 graphically depicts the predetermined defined preload to be 30 Nm. This again is customizable and therefore may be more or less than 30 Nm. The plurality of protrusions 156 may align the blade member package 112 and the sensing assembly 114 such that the pair of resilient members 160 and/or the plurality of protrusions 156 are configured to position the blade member package 112 to have the predetermined defined preload on the sensing assembly 114.

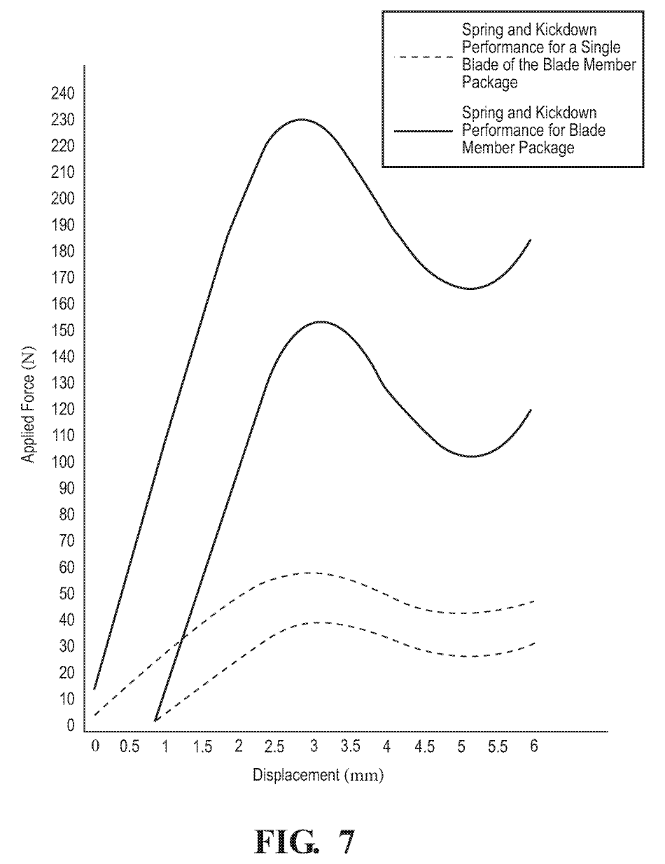

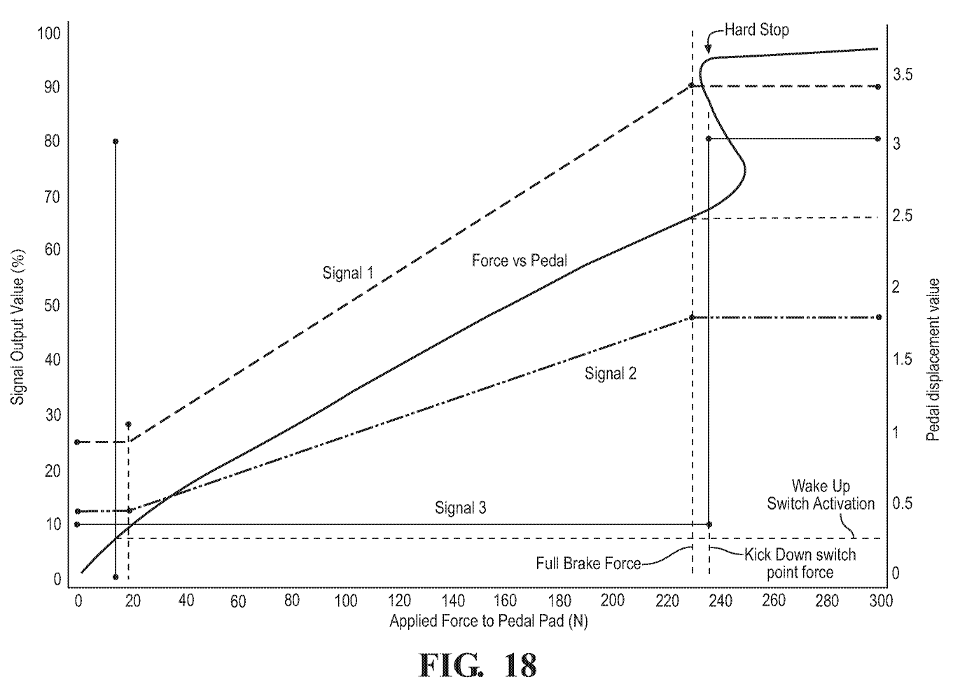

When the load L1 is applied to the pedal pad 110 and therefore to the pedal arm member 104, the blade member package 112 may be configured to flex or bend under this load, thereby changing the force (e.g., the change to the predetermined defined preload), which is detected via a pressure or force change by the sensing assembly 114, such as, without limitation, a change in strain, as discussed in greater detail herein. That is, each of the plurality of blade members 164 are sized and shaped to bend or flex based on a predetermined amount of force applied thereon from the load L1 applied to the pedal arm member 104 to achieve a desired force curve, such as the curve depicted in FIGS. 7 and 18, and as discussed in greater detail herein.

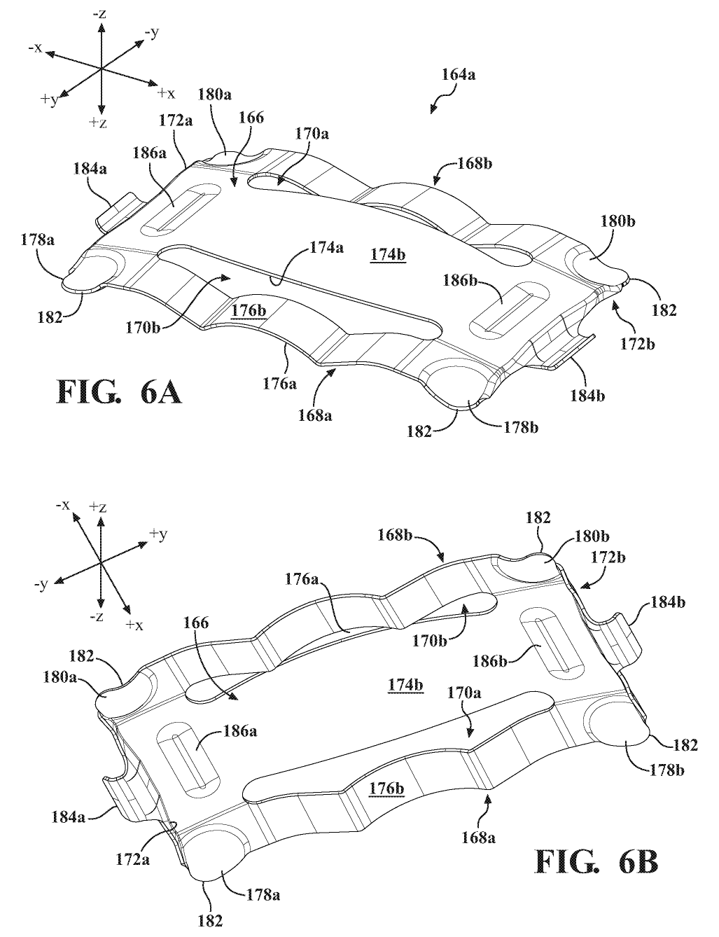

It should be understood that each of the plurality of blade members 164 are identical and therefore, for brevity reasons, only the blade member 164a of the plurality of blade members 164 will be described in detail with respect to FIGS. 6A-6B. However, the identical description applies to each of the plurality of blade members 164.

The blade member 164a is defined by a center portion 166 spaced apart from a pair of side peripheral portions 168a, 168b by a gap 170a, 170b. The center portion 166 is joined by a pair of end portions 172a, 172b. Each of the center portion 166 and the pair of end portions 172a, 172b have an inner blade surface 174a, and an opposite outer blade surface 174b to define a thickness. Further, each of the side peripheral portions 168a, 168b may be shaped as a wave or sinusoidal wave with an interior surface 176a and an opposite exterior surface 176b to define a thickness, which may be equal to the thickness of the center portion 166 and the pair of end portions 172a, 172b. As such, portions of the interior surface 176a and the exterior surface 176b may be above or below one another in the assembly vertical direction (i.e., in the +/- Z direction) depending on where in the wave or sinusoidal wave shape. Each of the side peripheral portions 168a, 168b may include a cup portion 178a, 178b, 180a, 180b, respectively, positioned at a terminating end adjacent or near the corresponding one of the pair of end portions 172a, 172b. Each of the cup portions 178a, 178b, 180a, 180b have an outer contour surface 182 configured to abut or engage with the retaining surface 158a of the corresponding one of the plurality of protrusions 156. Each of the pair of end portions 172a, 172b may further include a retaining portion 184a, 184b. Each of the retaining portions 184a, 184b may be curvilinear or arcuate in shape to form a “C” shape or a “U” shape. Each of the retaining portions 184a, 184b may be configured to be received by the corresponding tab member 162 of the pair of resilient members 160 to retain the retaining portions 184a, 184b therein. Each of the pair of end portions 172a, 172b may further include a indention portion 186a, 186b configured to assist in retaining the plurality of blade members 164 in the vertical stacked arrangement.

In operation, the center portion 166 flexes in a downward direction upon the load L1 applied onto the pedal arm member 104, which in turn causes each of the side peripheral portions 168a, 168b and/or cup portions 178a, 178b, 180a, 180b to flex in the opposite direction, or upward to cause a kick-down feature. As such, each of the plurality of blade members 164 are configured to provide the kick-down feature with a force up to, for example and without limitation, 230 N to the force measurement elements 304a, 304b of the sensing assembly 114, as discussed in greater detail herein, until there is a drop in a resistance and allows for further movement to a mechanical end stop without increasing the load on the sensing assembly 114 and thus prevents against overloading until the pedal arm member 104 interacts with a hard stop after a defined pedal stroke, as graphically illustrated in FIG. 7.

Each of the plurality of blade members 164 may be formed from a metal such as aluminum, steel, iron, copper, gold, titanium, alloys such as steel, bronze, and brass, combination thereof, and/or the like.

The pedal cover 106 includes an outer surface 188a and an opposite inner surface 188b to define a thickness. A lip portion 189 may extend around an outer periphery of the pedal cover 106 that may be defines by the outer surface 188a and the inner surface 188b. The lip portion 189 may include a pair of apertures 194 on either side that are positioned near the pivot end 126 of the housing 102 in the assembled state and co-axially aligned with the apertures 130, 132a, 132b of the housing 102 and apertures 154a, 154b of the pedal arm member 104 to receive the elongated member 134 to permit the pedal arm member to move about the elongated member 134, as discussed in greater detail herein.

The pedal cover 106 may further include an opening 190 that may be circumferentially surround by a continuous wall 192 extending from the outer surface 188a. The opening is configured to receive positions of the user interaction portion 138. For example, portions of the continuous wall 140, the top wall 144, and the top wall surface 146 of the pedal arm member 104 extend through the opening 190 in the assembly vertical direction (i.e., in the +/- Z direction) when the example pedal assembly is in the assembled state, as best illustrated in FIG. 1. As such, portions of the user interaction portion 138 of the pedal arm member 104 extend beyond the outer surface 188a of the pedal cover 106.

Further, in the assembled state, the inner surface 188b may abut or contact or be positioned adjacent to the exterior surface 136b and the lip portion 189 may overlap portions of the body 136c of the pedal arm member 104.

The pedal pad carrier 108 includes a coupling flange portion 196 opposite a pedal pad portion 198. The coupling flange portion 196 is sized and shaped to be received by the continuous wall 192 extending from the outer surface 188a of the pedal cover 106. Further, the pedal cover 106 includes a cavity 200 extending in the assembly vertical direction (e.g., in the +/- Z direction) from the coupling flange portion 196 in the direction towards the pedal pad portion 198. The cavity 200 is configured to receive the top wall 144 and portions of the 140 of the 138 such that the pedal pad carrier 108 is releasably coupled to both the pedal cover 106 and to the pedal arm member 104 such as in a snap-fit configuration, a press fit configuration, and/or the like.

The pedal pad 110 may be coupled to an outer surface 202 of the pedal pad portion 198 in a snap-fit configuration, a press fit configuration, and/or the like.

In some embodiments, each of the components of the housing 102, the pedal arm member 104, the pedal cover 106, and the pedal pad carrier 108 may be independent monolithic structures formed as a single structure. In other embodiments, components, or portions of the housing 102, the pedal arm member 104, the pedal cover 106, and the pedal pad carrier 108 may be coupled or otherwise attached together via at least one fastener. Example fasteners include, without limitation, bolt and nut, screw, rivet, weld, adhesive, epoxy, and/or the like.

The housing 102, the pedal arm member 104, the pedal cover 106, and the pedal pad carrier 108, as well as any of the other portions or components of the housing 102, the pedal arm member 104, the pedal cover 106, and the pedal pad carrier 108 may be independently manufactured as separate components such as by using injection molding techniques, additive manufacturing, and/or the like, or may integrated with one another, i.e., may be a single monolithic structure that is formed together, such as by using injection molding techniques, additive manufacturing, and/or the like.

As used herein, “additive manufacturing” refers generally to manufacturing processes wherein successive layers of material(s) are provided on each other to “build-up,” layer-by-layer, a three-dimensional component. The successive layers generally fuse together to form a monolithic component which may have a variety of integral sub-components. Although additive manufacturing technology is described herein as enabling fabrication of complex objects by building objects point-by-point, layer-by-layer, typically in a vertical direction, other methods of fabrication are possible and within the scope of the present subject matter. For example, although the discussion herein refers to the addition of material to form successive layers, one skilled in the art will appreciate that the methods and structures disclosed herein may be practiced with any additive manufacturing technique or manufacturing technology. For example, embodiments of the present invention may use layer-additive processes, layer-subtractive processes, or hybrid processes.

Suitable additive manufacturing techniques in accordance with the present disclosure include, for example, Fused Deposition Modeling (FDM), Selective Laser Sintering (SLS), 3D printing such as by inkjets and laserjets, Sterolithography (SLA), Direct Selective Laser Sintering (DSLS), Electron Beam Sintering (EBS), Electron Beam Melting (EBM), Laser Engineered Net Shaping (LENS), Laser Net Shape Manufacturing (LNSM), Direct Metal Deposition (DMD), Digital Light Processing (DLP), Direct Selective Laser Melting (DSLM), Selective Laser Melting (SLM), Direct Metal Laser Melting (DMLM), and other known processes.

The additive manufacturing processes described herein may be used for forming components using any suitable material. For example, the material may be plastic, metal, concrete, ceramic, polymer, epoxy, photopolymer resin, or any other suitable material that may be in solid, liquid, powder, sheet material, wire, or any other suitable form. More specifically, according to exemplary embodiments of the present subject matter, the additively manufactured components described herein may be formed in part, in whole, or in some combination of materials including but not limited to pure metals, nickel alloys, chrome alloys, titanium, titanium alloys, magnesium, magnesium alloys, aluminum, aluminum alloys, and nickel or cobalt base superalloys (e.g., those available under the name Inconel® available from Special Metals Corporation). These materials are examples of materials suitable for use in the additive manufacturing processes described herein, and may be generally referred to as “additive materials.”

In addition, one skilled in the art will appreciate that a variety of materials and methods for bonding those materials may be used and are contemplated as within the scope of the present disclosure. As used herein, references to “fusing” may refer to any suitable process for creating a bonded layer of any of the above materials. For example, if an object is made from polymer, fusing may refer to creating a thermoset bond between polymer materials. If the object is epoxy, the bond may be formed by a crosslinking process. If the material is ceramic, the bond may be formed by a sintering process. If the material is powdered metal, the bond may be formed by a melting or sintering process. One skilled in the art will appreciate that other methods of fusing materials to make a component by additive manufacturing are possible, and the presently disclosed subject matter may be practiced with those methods.

In addition, the additive manufacturing process disclosed herein allows a single component to be formed from multiple materials. Thus, the components described herein may be formed from any suitable mixtures of the above materials. For example, a component may include multiple layers, segments, or parts that are formed using different materials, processes, and/or on different additive manufacturing machines. In this manner, components may be constructed which have different materials and material properties for meeting the demands of any particular application. In addition, although the components described herein are constructed entirely by additive manufacturing processes, it should be appreciated that in alternate embodiments, all or a portion of these components may be formed via casting, machining, and/or any other suitable manufacturing process. Indeed, any suitable combination of materials and manufacturing methods may be used to form these components.

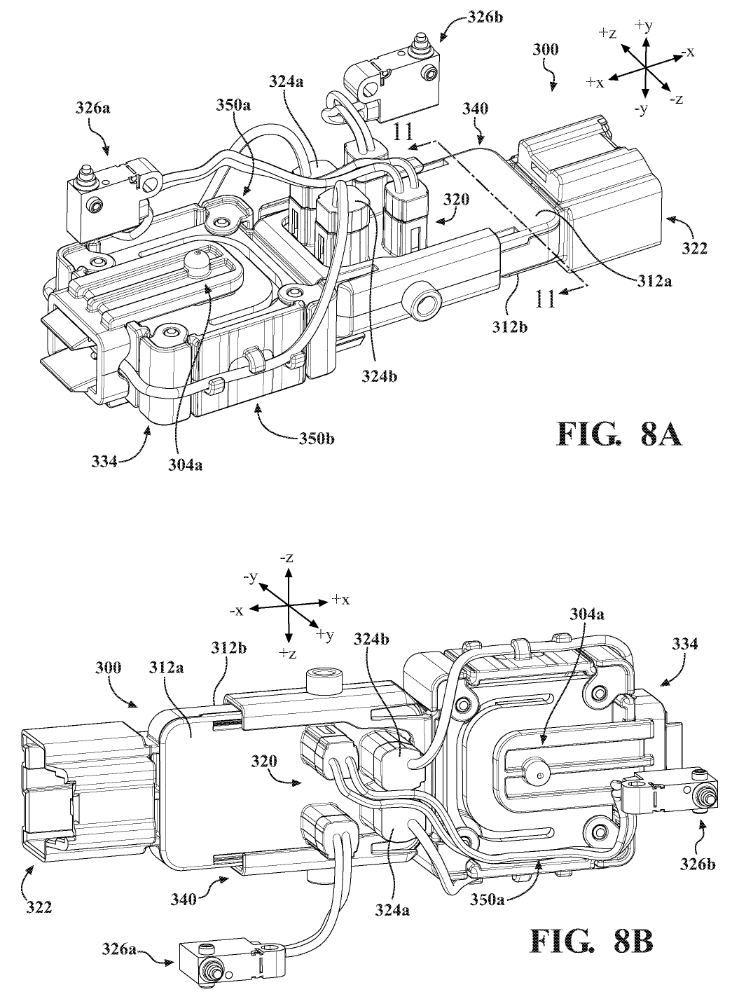

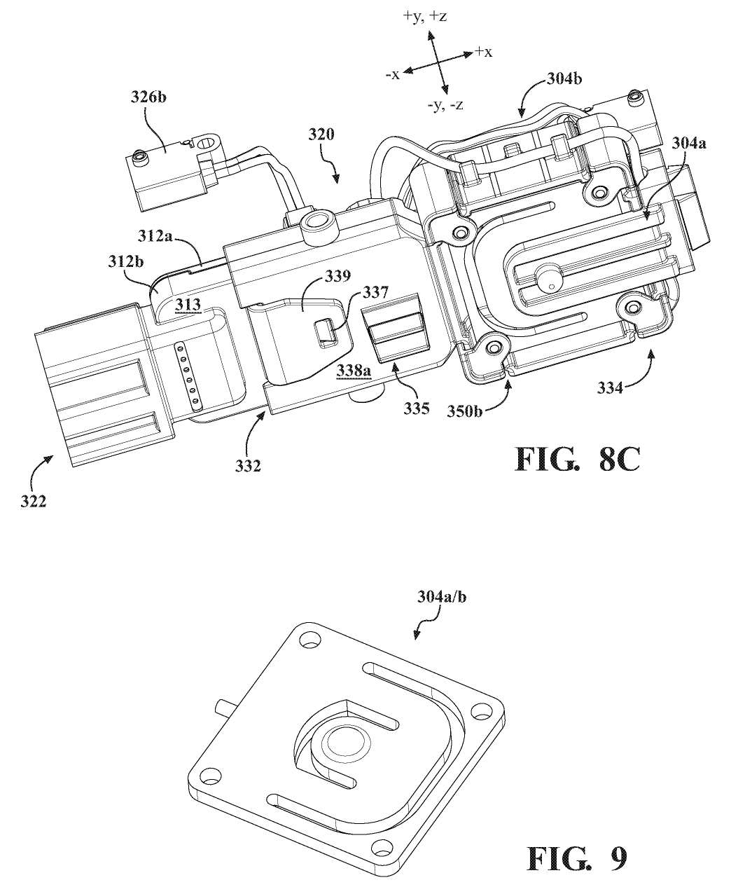

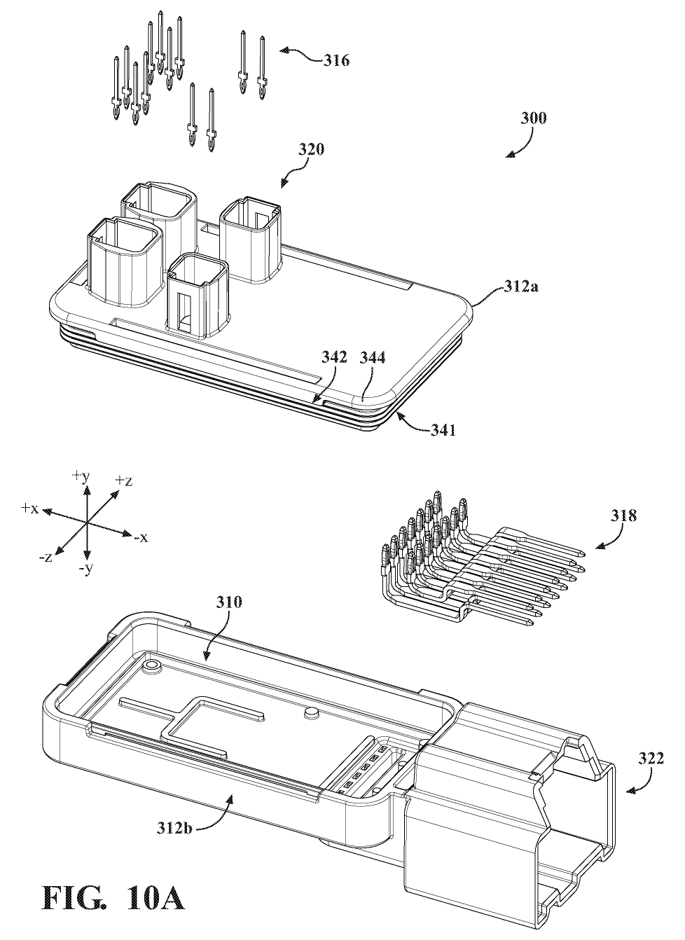

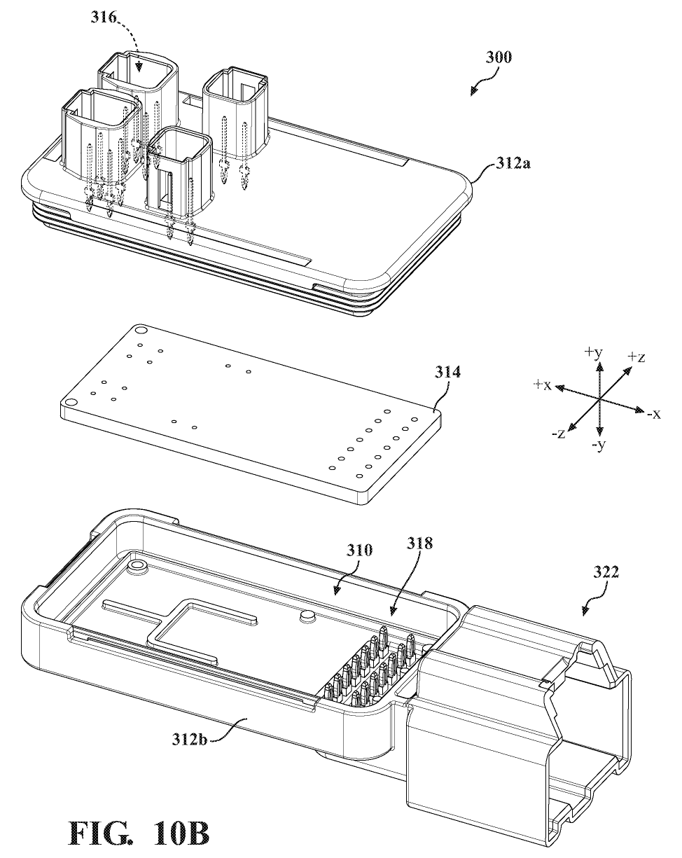

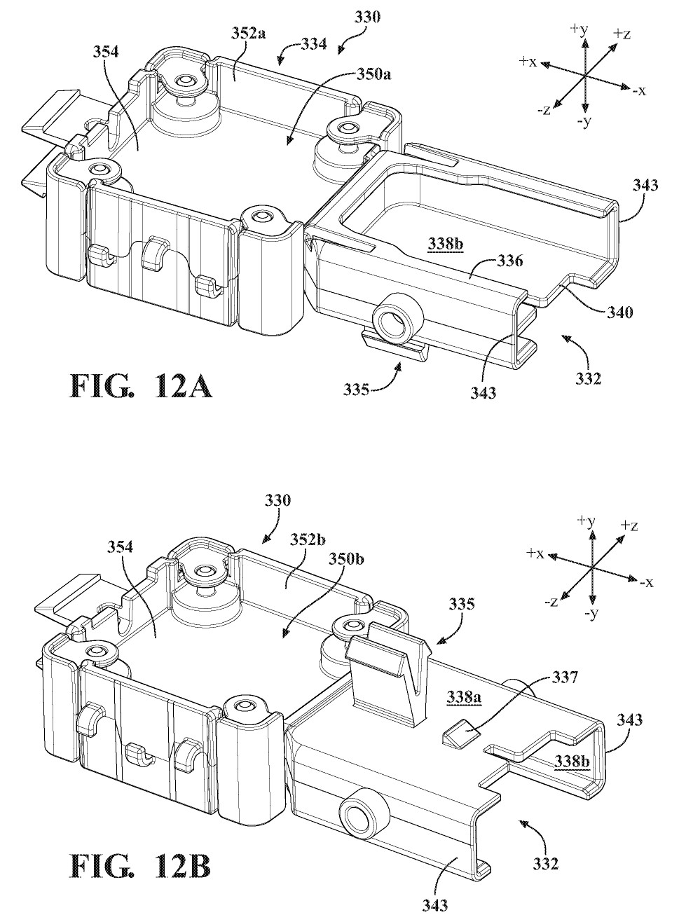

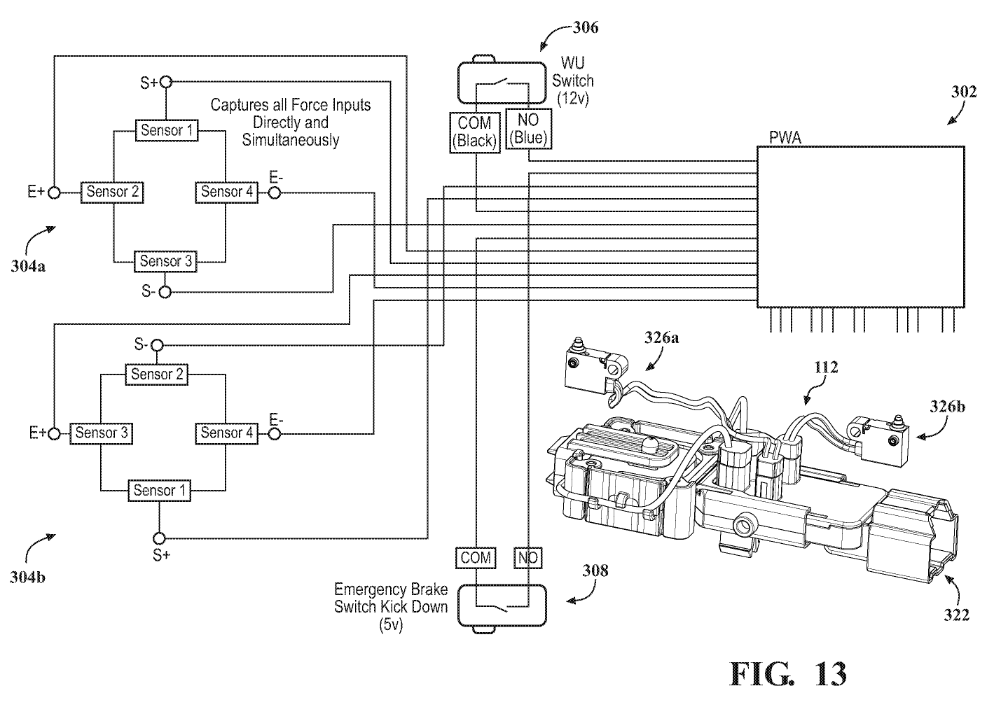

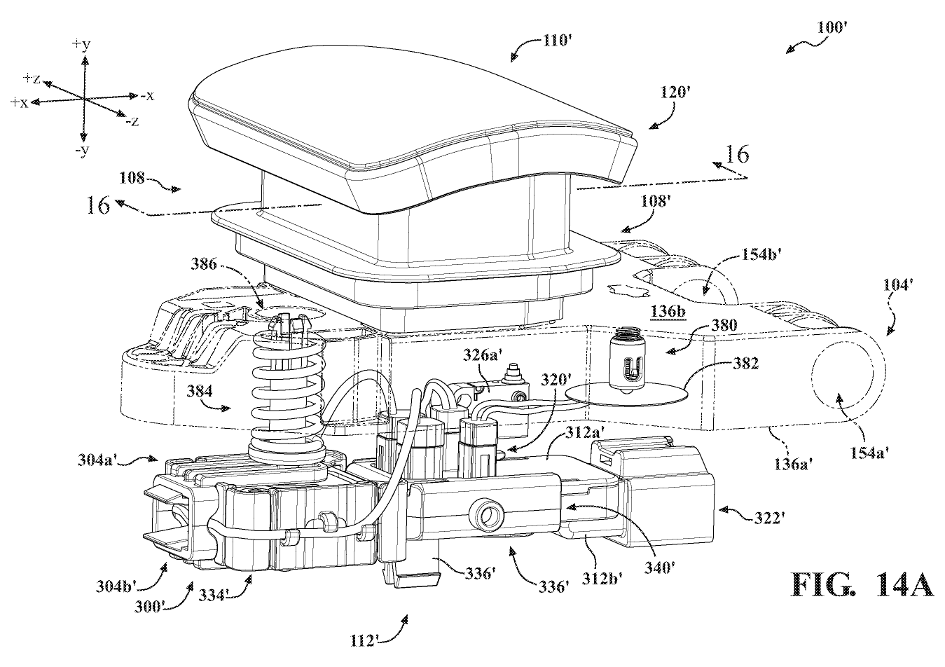

Now referring to FIGS. 8A-13, the sensing assembly 114 may be an electronic module that includes a housing 300, a printed wiring assembly (PWA) 302, at least a pair of force measurement elements 304a, 304b, a wake-up switch 306, and an emergency brake switch 308, along with the associated circuitry, as best depicted in FIGS. 8A-8B and 13. Each of the pair of force measurement elements may be any measurement device capable of detecting force, such as, without limitation, strain gauges, load cells, piezoelectric sensors, force-sensing resistors (FSRs), capacitive force sensors, and/or the like.

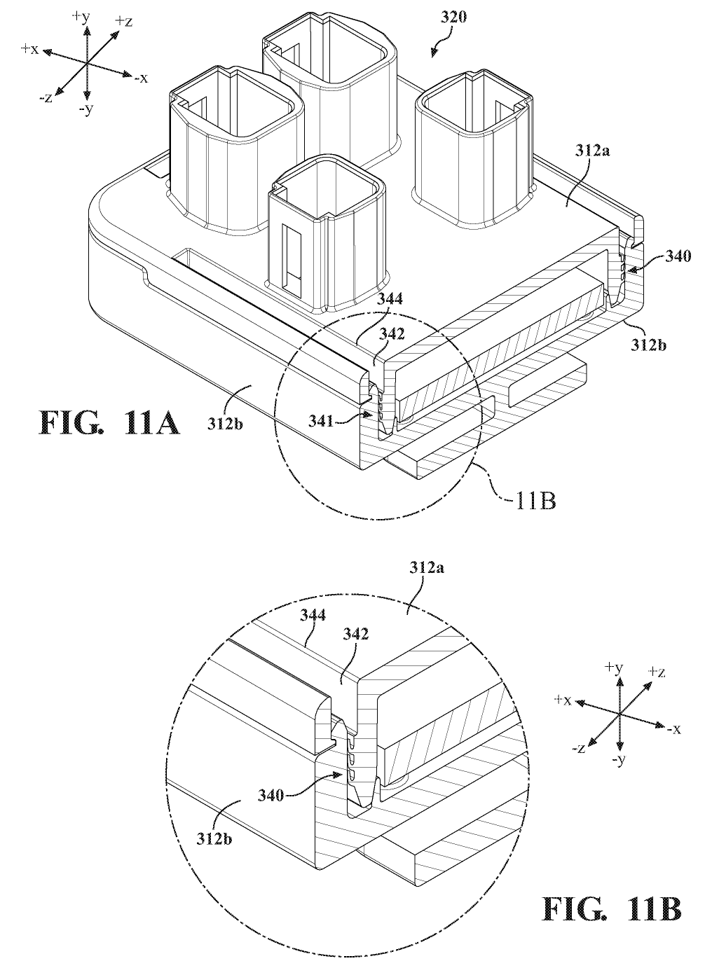

Portions of the PWA 302 are positioned within a cavity portion 310 the housing 300, which may be defined by an upper housing member 312a and an opposite lower housing member 312b. The upper housing member 312a may include a plurality of slats 341 extending partially or fully around a terminating surface 342, which may be define an outer periphery 344 of the upper housing member 312a. As best depicted in FIGS. 11A-11B, when the upper housing member 312a is mated with (e.g., inserted into) and coupled to the lower housing member 312b, the plurality of slats 341 are configured to deform or bend, thus forming a seal between the upper housing member 312a and the lower housing member 312b. Such an arrangement provides for an elimination of a seal required here in conventional assemblies and for less manufacturing steps.

The upper housing member 312a and the lower housing member 312b may couple to one another in a snap-fit arrangement, a press fit arrangement, and/or the like. The upper housing member 312a and the lower housing member 312b may be overmolded, injection molded, and/or additive manufactured, as described above.

The PWA 302 may include a circuit board 314 configured for electronic and for terminal pins 316 to output from the PWA 302 through a plurality of connector ports 320 formed within the upper housing member 312a and a plurality of terminal pins 318 extending from the circuit board 314 into an external connector port 322 formed in the lower housing member 312b. The external connector port 322 may be configured to receive a vehicle side harness to communicatively couple the sensing assembly 114 to an electronic control unit or other controller of the vehicle. In a non-limiting example, the plurality of terminal pins 318 and the external connector port 322 may be configured for a 14 pin wiring harness.

Two of the plurality of connector ports 320 are configured to receive a connector 324a, 324b extending from each of the pair of force measurement elements 304a, 304b, respectively, to communicatively couple the PWA 302 to each of the pair of the force measurement elements 304a, 304b. The other two of the plurality of connector ports 320 include a connector interface 326a, 326b, respectively. The connector interface 326a is configured to communicatively coupling of the wake-up switch 306 to the PWA 302 and the connector interface 326b is configured to communicatively coupling the emergency brake switch 308 to the PWA 302.

The sensing assembly 114 may further include a force measurement housing 330. The force measurement housing 330 may include a receiving channel portion 332 and an opposite sensing cavity portion 334. A resilient member 335 and a tab member 337 each extend from an outer surface 338a, opposite of the inner surface 338b, of the receiving channel portion 332. A bottom surface 313 of the lower housing member 312b may include a receiving tab member 339 that when assembled into the force measurement housing 330, receives the tab member 337, as discussed in greater detail herein. The receiving channel portion 332 includes a lip portion 336, sidewall portions 343, and end wall portion 340 that are configured to receive portions of the housing 300 to retain or otherwise attach or couple the force measurement housing 330 to the housing 300 along the inner surface 338b of the receiving channel portion 332.

The sensing cavity portion 334 includes a pair of cavities 350a, 350b positioned on opposite sides of one another defined by continuous walls 352a, 352b, respectively, and separated by floor 354. Each of the pair of force measurement elements 304a, 304b may be mounted to the corresponding continuous walls 352a, 352b at the corresponding pair of cavities 350a, 350b. One of the force measurement element 304a interacts with the blade member package 112 while the other one of the force measurement element 304b contacts or interacts with the floor surface 120c of the housing 102 based on the amount of load applied. As such, the pair of force measurement elements 304a, 304b independently sense two different forces acting upon them for redundancy purposes. Further, it should be appreciated that the sensing cavity portion and/or the corresponding pair of cavities 350a, 350b may be co-axially aligned with at least portions of the blade member package 112 to co-axially align at least one of the pair of force measurement elements 304a, 304b with the blade member package 112.

In operation, the amount of load L1 applied to the pedal arm member 104 applies a force onto the blade member package 112, which in turn bends or flexes into at least one of the force measurement elements 304a, which is configured to measure the amount of force, such as, without limitation, a strain, applied thereon, indicative to the load L1 applied to the pedal arm member 104. The other force measurement element 304b, is driven or moved into the floor surface 120c of the housing, to measure the amount of force, such as, without limitation, a second strain, applied thereon, indicative to the load L1 applied to the pedal arm member 104, as a redundant verification.

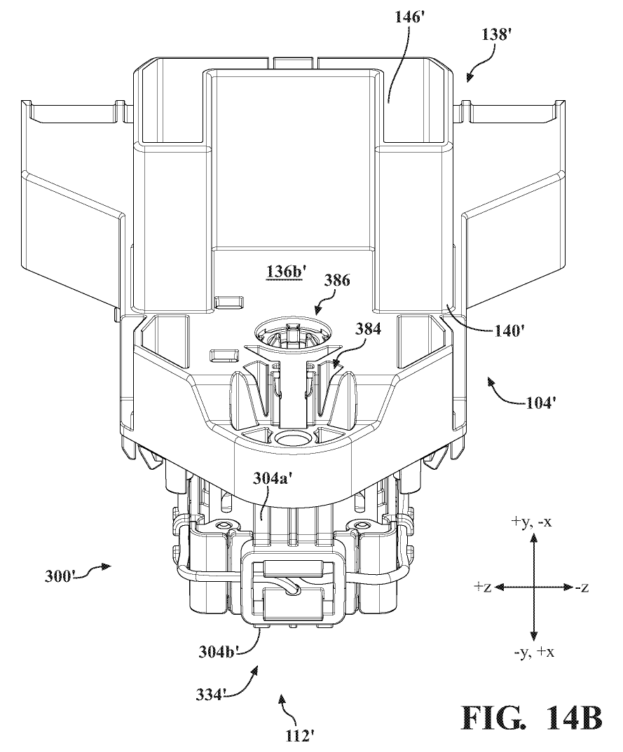

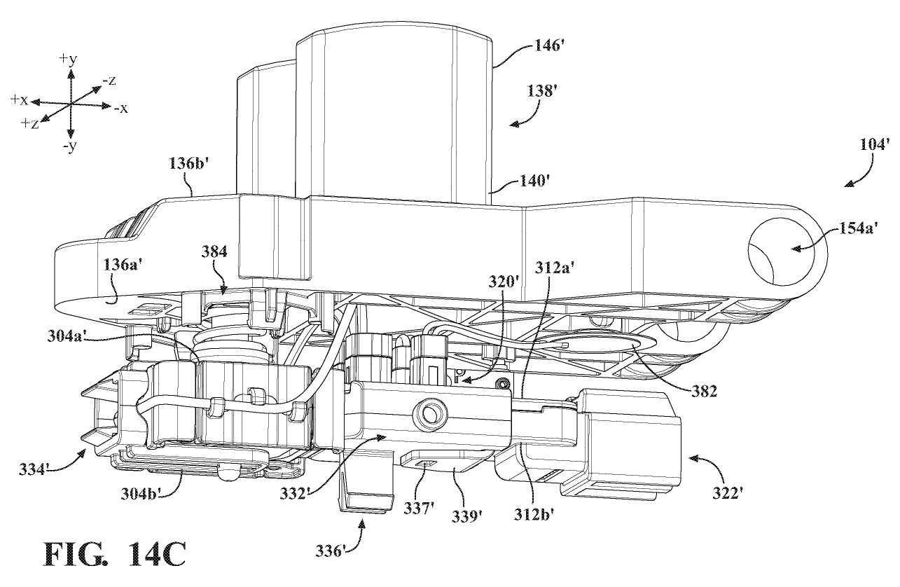

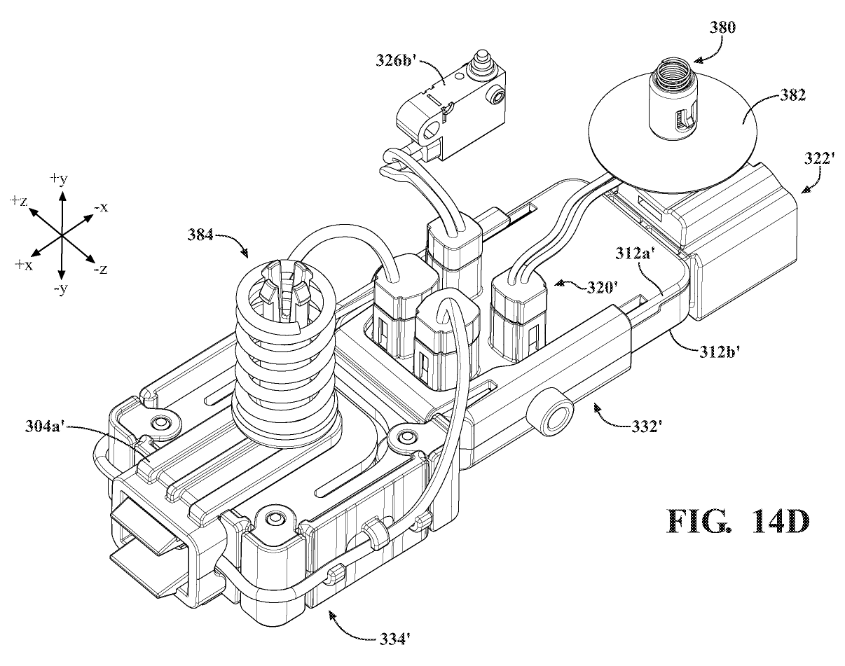

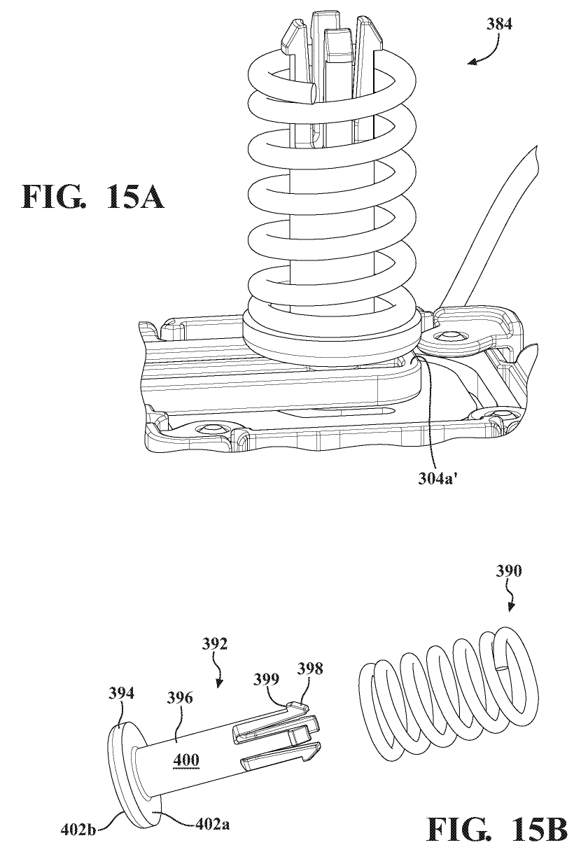

Now referring to FIGS. 14A-16, a second aspect of the example pedal assembly 100’ is schematically depicted. It is understood that the example pedal assembly 100’ is similar to the example pedal assembly 100 with the exceptions of the features described herein. As such, like features will use the same reference numerals with a suffix apostrophe “’” for the reference numbers. As such, for brevity reasons, these features will not be described again.

In the example pedal assembly 100’, the wakeup switch 306 is replaced with a mechanical piezo electric element 380 positioned on a platform 382 and in contact with the interior surface 136a’ of the pedal arm member 104’. The piezo electric element 380 is communicatively coupled to the PWA 302’. In operation, when a force or load is applied to the pedal pad 110’, this force is translated over the pivoting point define by arrow A1 in FIG. 1, to the spring-loaded Piezo push element 380. The force compresses the spring and applies a load to the Piezo push element 380, which in turn creates an electrical resonance effect that is transmitted directly to the PWA 302’.

In addition, or alternatively, the blade member package 112 is replaced with a biasing member assembly 384. The biasing member assembly 384 extends between the at least one force measurement element 304a’ and an aperture 386 of the pedal arm member 104’. That is, it is contemplated that the wakeup switch may be piezo electric element 380 while the blade member package is utilized. Alternatively, the piezo electric element 380 may be used along with the biasing member assembly 384.

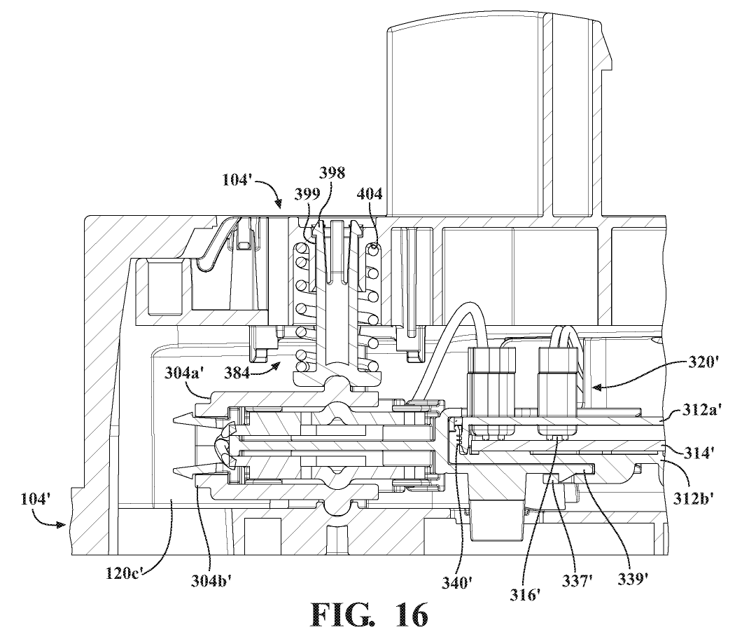

The biasing member assembly 384 may include a compressible member, such as a spring 390 and elongated member 392. The elongated member 392 may have a body 396 with an exterior surface 400. The body 396 may include a plurality of resilient members 398 with a tab 399 at a distal end, opposite a base portion 394. The base portion 394 has an inner surface 402a and an opposite outer surface 402b. The outer surface 402b is configured to engage with the force measurement elements 304a’ 304b’, as discussed in detail herein The compressible member, such as a spring 390 extends between the inner surface 402a and a compressible member receiving surface 404 of the pedal arm, as best illustrated in FIG. 16. Portions of the plurality of resilient members 398 and the tab 399 engage with the aperture 386 of the pedal arm member 104.

It should be appreciated that this arrangement does not require the force to be acted on a certain part of the pedal pad 110, but instead a force or load anywhere on the pedal pad 110 results into the force applied at the force transducer (e.g., force measurement elements 304a, 304b). The standard ratio starting from the center of the pedal pad 110 is in the current case i=1.7, depending on whether the force is introduced further up or down on the pedal pad 110. As such, the force aspects are balanced in the mechanical component.

In operation, when the force or load L1 is applied anywhere to the pedal pad 110, the pedal arm member 104 rotates about the elongated member 134 in the direction of arrow A1 into a spring loaded piezo push element 380, thereby compressing a spring to apply a load to the piezo push element 380, which in turn creates an electrical resonance that is sent directly to the PWA 302 as a wake-up signal (e.g., causes the PWA 302 to become operational, thereby consuming more power than the power consumed before the signal was sent to the PWA 302 (e.g., in a powered-off state)). Further in the operational state the PWA 302 may generate a signal to be sent to external ECUs on the vehicle side through the wake-up switch 306.

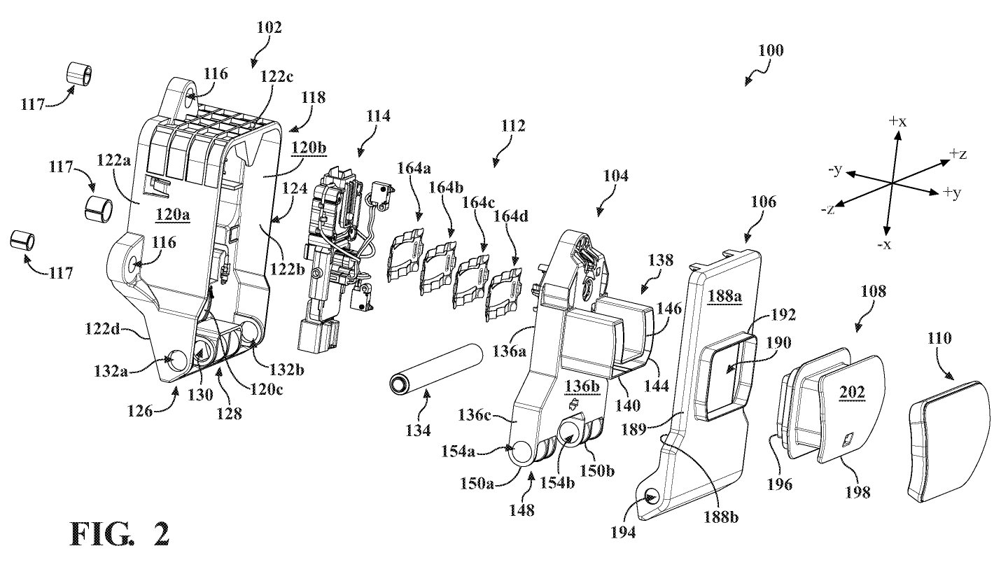

FIG. 17 graphically depicts the force in newton which effects to the force measurement elements 304a, 304b (FIG. 13) between 0 mm and 6 mm of the blade member stroke or displacement of the blade member package 112 (FIG. 2). Accordingly, in an non-limiting example, as depicted, a minimum load of 30N will always be present and maximum load which will be applied to the at least one of the force measurement elements 304a, 304b (FIG. 13) is approximately 280 N. Again, as discussed earlier, this is customizable and is not limiting.

FIG. 18 graphically depicts a force profile between idle pedal position up to fully applied pedal position in Newton vs mm and the equivalent sensor outputs in sensor Value 0/100 vs force 0 to 300 N. FIG. 18 also depicts that when the applied force or load is over 250 N, the mechanical end stop is activated. As depicted, the wake-up switch is activated at approximately 20N of applied force or load. This is based on the forces at the actuation point at the pedal pad 110.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

It is also noted that recitations herein of “at least one” component, element, etc., should not be used to create an inference that the alternative use of the articles “a” or “an” should be limited to a single component, element, etc.

It is noted that recitations herein of a component of the present disclosure being "configured" or “programmed” in a particular way, to embody a particular property, or to function in a particular manner, are structural recitations, as opposed to recitations of intended use.

It is noted that one or more of the following claims utilize the term “wherein” as a transitional phrase. For the purposes of defining the present disclosure, it is noted that this term is introduced in the claims as an open-ended transitional phrase that is used to introduce a recitation of a series of characteristics of the structure and should be interpreted in like manner as the more commonly used open-ended preamble term “comprising.”

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

### ASPECTS LISTING

Aspect 1. A pedal assembly including a housing, a pedal arm member movably coupled to the housing, the pedal arm member having an interior surface and an opposite exterior surface, a plurality of protrusions extending from the interior surface of the pedal arm member, a blade member package having a plurality of blade members stacked in a vertical arrangement, the blade member package received by the plurality of protrusions to couple the blade member package to the interior surface of the pedal arm member, and a sensing assembly positioned within the housing, the sensing assembly including at least one force measurement element configured to sense a change in force, wherein when a load is applied to the pedal arm member, the pedal arm member and the blade member package are driven into the at least one force measurement element configured to measure a force applied by the blade member package indicative of an amount of the load applied to the pedal arm member based on the amount of change of the force.

Aspect 2. The pedal assembly of Aspect 1 wherein each of the plurality of blade members of the blade member package further include a center portion, a pair of side peripheral portions spaced apart from the center portion by a gap, each of the pair of side peripheral portions shaped as a wave, and a pair of end portions joined to the center portion.

Aspect3. The pedal assembly of any of Aspect 1 to Aspect 2, wherein each of the plurality of blade members of the blade member package are sized and shaped to bend or flex to a predetermined amount of force applied thereon to reduce overloading the at least one force measurement elements.

Aspect 4. The pedal assembly of any of Aspect 1 to Aspect 3, wherein each of the plurality of blade members of the blade member package are sized and shaped to bend or flex to a predetermined amount of force applied thereon to achieve a desired force curve.

Aspect 5. The pedal assembly of any of Aspect 1 to Aspect 4, wherein the plurality of protrusions align the plurality of blade members and the sensing assembly.

Aspect 6. The pedal assembly of any of Aspect 1 to Aspect 5, further including a pair of resilient members configured to couple the each of the plurality of blade members of the blade member package to the interior surface of the pedal arm member, wherein the plurality of protrusions or the pair of resilient members are configured to position the blade member package to have a predetermined defined preload on the sensing assembly.

Aspect 7. The pedal assembly of any of Aspect 1 to Aspect 6, further including a pedal arm cover having an upper surface, an opposite lower surface, and an aperture extending therethrough, the aperture configured to receive a user interaction portion of the pedal arm member to extend beyond the upper surface and the lower surface abuts other portions of the pedal arm member.

Aspect 8. The pedal assembly of any of Aspect 1 to Aspect 7, further including a pedal pad carrier having an a receiving cavity configured to receive positions of the user interaction portion of the pedal arm member extending beyond the upper surface, portions of the pedal pad carrier received within the aperture to couple the pedal pad carrier to the pedal pad cover.

Aspect 9. The pedal assembly of any of Aspect 1 to Aspect 8, wherein the sensing assembly further includes a sensing housing defined by an upper housing member and a lower housing member, an outer periphery of the upper housing member includes a plurality of slats configured to deform when mated with the lower housing member, wherein the deformation of the plurality of slats is by contact with the lower housing member to provide a seal between the upper housing member and the lower housing member.

Aspect 10. The pedal assembly of any of Aspect 1 to Aspect 9, wherein the sensing assembly further includes a force measurement housing defined by receiving channel portion and a sensing cavity portion, the receiving channel portion is configured to receive portions of the sensing housing to couple the sensing housing to the force measurement housing, wherein the at least one force measurement element is positioned at the sensing cavity portion to co-axially align with at least portions of the plurality of blade member package.

Aspect 11. The pedal assembly of any of Aspects 1-10.

Aspect 12. An assembly includes a housing, a pedal arm member movably coupled to the housing, the pedal arm member having an interior surface and an opposite exterior surface, the pedal arm member further including: a plurality of protrusions extending from the interior surface of the pedal arm member; and a pair of resilient members extending from the interior surface of the pedal arm member, a blade member package having a plurality of blade members stacked in a vertical arrangement, the blade member package received by the plurality of protrusions to abut an inner surface thereof and by the pair of resilient members to couple the blade member package to the interior surface of the pedal arm member, and a sensing assembly positioned within the housing, the sensing assembly including at least one force measurement element configured to sense a change in force, wherein the plurality of protrusions or the pair of resilient members are configured to position the blade member package to have a predetermined defined preload on the sensing assembly wherein when a load is applied to the pedal arm member, the pedal arm member and the blade member package are driven into the at least one force measurement element configured to measure a force applied by the blade member package indicative of an amount of the load applied to the pedal arm member based on the amount of change of the force from an idle position.

Aspect 13. The assembly of Aspect 12, wherein each of the plurality of blade members of the blade member package further include a center portion, a pair of side peripheral portions spaced apart from the center portion by a gap, each of the pair of side peripheral portions shaped as a wave, and a pair of end portions joined to the center portion.

Aspect 14. The assembly of any of Aspect 12 to Aspect 13, wherein each of the plurality of blade members of the blade member package are sized and shaped to bend or flex to a predetermined amount of force applied thereon to reduce overloading the at least one force measurement element .

Aspect 15. The assembly of any of Aspect 12 to Aspect 14, wherein each of the plurality of blade members of the blade member package are sized and shaped to bend or flex to a predetermined amount of force applied thereon to achieve a desired force curve.

Aspect 16. The assembly of any of Aspect 12 to Aspect 15, wherein the plurality of protrusions align the plurality of blade members and the sensing assembly.

Aspect 17. The assembly of any of Aspect 12 to Aspect 16, further including a pedal arm cover having an upper surface, an opposite lower surface, and an aperture extending therethrough, the aperture configured to receive a user interaction portion of the pedal arm member to extend beyond the upper surface and the lower surface abuts other portions of the pedal arm member.

Aspect 18. The assembly of any of Aspect 12 to Aspect 17, further including a pedal pad carrier having an a receiving cavity configured to receive positions of the user interaction portion of the pedal arm member extending beyond the upper surface, portions of the pedal pad carrier received within the aperture to couple the pedal pad carrier to the pedal pad cover.

Aspect 19. The assembly of any of Aspect 12 to Aspect 18, wherein the sensing assembly further includes a sensing housing defined by an upper housing member and a lower housing member, an outer periphery of the upper housing member includes a plurality of slats configured to deform when mated with the lower housing member, wherein the deformation of the plurality of slats is by contact with the lower housing member to provide a seal between the upper housing member and the lower housing member.

Aspect 20. The assembly of any of Aspect 12 to Aspect 19, wherein the sensing assembly further includes a force measurement housing defined by receiving channel portion and a sensing cavity portion, the receiving channel portion is configured to receive portions of the sensing housing to couple the sensing housing to the force measurement housing, wherein the at least one force measurement element is positioned at the sensing cavity portion to co-axially align with at least portions of the plurality of blade member package.

Aspect 21. The assembly of any of Aspect 12 to Aspect 20, wherein the at least one force measurement elements is a pair of force measurement elements, one force measurement element of the pair of force measurement elements is configured to interact with the blade member package and the other force measurement element of the pair of force measurement elements is configured to interact with a floor surface of the housing.

Aspect 22. The assembly of any of Aspect 12 to Aspect 21.

Aspect 23. A method including any combination of features of any of Aspects 1 to Aspect 22.

1. A pedal assembly comprising:
a housing;
a pedal arm member movably coupled to the housing, the pedal arm member having an interior surface and an opposite exterior surface, a plurality of protrusions extending from the interior surface of the pedal arm member; and
a blade member package having a plurality of blade members stacked in a vertical arrangement, the blade member package received by the plurality of protrusions to couple the blade member package to the interior surface of the pedal arm member; and
a sensing assembly positioned within the housing, the sensing assembly including at least one force measurement element configured to sense a change in force,
wherein when a load is applied to the pedal arm member, the pedal arm member and the blade member package are driven into the at least one force measurement element configured to measure a force applied by the blade member package indicative of an amount of the load applied to the pedal arm member based on the amount of change of the force.

2. The pedal assembly of claim 1, wherein each of the plurality of blade members of the blade member package further comprise:
a center portion;
a pair of side peripheral portions spaced apart from the center portion by a gap, each of the pair of side peripheral portions shaped as a wave; and
a pair of end portions joined to the center portion.

3. The pedal assembly of claim 2, wherein each of the plurality of blade members of the blade member package are sized and shaped to bend or flex to a predetermined amount of force applied thereon to reduce overloading the at least one force measurement element.

4. The pedal assembly of claim 2, wherein each of the plurality of blade members of the blade member package are sized and shaped to bend or flex to a predetermined amount of force applied thereon to achieve a desired force curve.

5. The pedal assembly of claim 1, wherein the plurality of protrusions align the plurality of blade members and the sensing assembly.

6. The pedal assembly of claim 5, further comprising:
a pair of resilient members configured to couple the each of the plurality of blade members of the blade member package to the interior surface of the pedal arm member,
wherein the plurality of protrusions or the pair of resilient members are configured to position the blade member package to have a predetermined defined preload on the sensing assembly.

7. The pedal assembly of claim 1, further comprising:
a pedal arm cover having an upper surface, an opposite lower surface, and an aperture extending therethrough, the aperture configured to receive a user interaction portion of the pedal arm member to extend beyond the upper surface and the lower surface abuts other portions of the pedal arm member.

8. The pedal assembly of claim 7, further comprising:
a pedal pad carrier having an a receiving cavity configured to receive positions of the user interaction portion of the pedal arm member extending beyond the upper surface, portions of the pedal pad carrier received within the aperture to couple the pedal pad carrier to the pedal pad cover.

9. The pedal assembly of claim 1, wherein the sensing assembly further comprises:
a sensing housing defined by an upper housing member and a lower housing member, an outer periphery of the upper housing member includes a plurality of slats configured to deform when mated with the lower housing member,
wherein the deformation of the plurality of slats is by contact with the lower housing member to provide a seal between the upper housing member and the lower housing member.

10. The pedal assembly of claim 9, wherein the sensing assembly further comprises:
a force measurement housing defined by receiving channel portion and a sensing cavity portion, the receiving channel portion is configured to receive portions of the sensing housing to couple the sensing housing to the force measurement housing,
wherein the at least one force measurement element is positioned at the sensing cavity portion to co-axially align with at least portions of the plurality of blade member package.

11. An assembly comprising:
a housing;
a pedal arm member movably coupled to the housing, the pedal arm member having an interior surface and an opposite exterior surface, the pedal arm member further including:
a plurality of protrusions extending from the interior surface of the pedal arm member; and
a pair of resilient members extending from the interior surface of the pedal arm member;
a blade member package having a plurality of blade members stacked in a vertical arrangement, the blade member package received by the plurality of protrusions to abut an inner surface thereof and by the pair of resilient members to couple the blade member package to the interior surface of the pedal arm member; and
a sensing assembly positioned within the housing, the sensing assembly including at least one force measurement element configured to sense a change in force,
wherein the plurality of protrusions or the pair of resilient members are configured to position the blade member package to have a predetermined defined preload on the sensing assembly, and
wherein when a load is applied to the pedal arm member, the pedal arm member and the blade member package are driven into the at least one force measurement element configured to measure a force applied by the blade member package indicative of an amount of the load applied to the pedal arm member based on the amount of change of the force from an idle position.

12. The assembly of claim 11, wherein each of the plurality of blade members of the blade member package further comprise:
a center portion;
a pair of side peripheral portions spaced apart from the center portion by a gap, each of the pair of side peripheral portions shaped as a wave; and
a pair of end portions joined to the center portion.

13. The assembly of claim 12, wherein each of the plurality of blade members of the blade member package are sized and shaped to bend or flex to a predetermined amount of force applied thereon to reduce overloading the at least one force measurement element.

14. The assembly of claim 12, wherein each of the plurality of blade members of the blade member package are sized and shaped to bend or flex to a predetermined amount of force applied thereon to achieve a desired force curve.

15. The assembly of claim 12, wherein the plurality of protrusions align the plurality of blade members and the sensing assembly.

16. The assembly of claim 11, further comprising:
a pedal arm cover having an upper surface, an opposite lower surface, and an aperture extending therethrough, the aperture configured to receive a user interaction portion of the pedal arm member to extend beyond the upper surface and the lower surface abuts other portions of the pedal arm member.

17. The assembly of claim 16, further comprising:
a pedal pad carrier having an a receiving cavity configured to receive positions of the user interaction portion of the pedal arm member extending beyond the upper surface, portions of the pedal pad carrier received within the aperture to couple the pedal pad carrier to the pedal pad cover.

18. The assembly of claim 11, wherein the sensing assembly further comprises:
a sensing housing defined by an upper housing member and a lower housing member, an outer periphery of the upper housing member includes a plurality of slats configured to deform when mated with the lower housing member,
wherein the deformation of the plurality of slats is by contact with the lower housing member to provide a seal between the upper housing member and the lower housing member.

19. The assembly of claim 18, wherein the sensing assembly further comprises:
a force measurement housing defined by receiving channel portion and a sensing cavity portion, the receiving channel portion is configured to receive portions of the sensing housing to couple the sensing housing to the force measurement housing,
wherein the at least one force measurement element is positioned at the sensing cavity portion to co-axially align with at least portions of the plurality of blade member package.

20. The assembly of claim 18, wherein the at least one force measurement element is a pair of force measurement elements, one force measurement element of the pair of force measurement elements is configured to interact with the blade member package and the other force measurement element of the pair of force measurement elements is configured to interact with a floor surface of the housing.
